(19) United States
(12) Patent Application Publication
(10) Pub. No.: US 2006/0060619 A1
(43) Pub. Date: Mar. 23, 2006

(54) Apparatus for disposing of liquids in the medical field, especially for disposing of dialysates

(76) Inventor: Konrad Hageneder, Pettenbach (AT)

Correspondence Address: Kurt Kelman;COLLARD & ROE, P.C., 1077 Northern Boulevard, Roslyn, NY, 11576, US

(21) Appl. No.: 11/013,878

(22) Filed: Dec. 16, 2004

(30) Foreign Application Priority Data
Sep. 17, 2004 (AT) A 1566/2004

(51) Int. Cl. B60P 3/22

(52) U.S. Cl. 222/608

(57) ABSTRACT

An apparatus is described for disposing of liquids in the medical field, especially for disposing of dialysates, comprising a self-supporting container (1) which is movably supported on support wheels (2) and a discharge device for the liquid filled into the container (1) via a sealable filling opening (5), with the discharge device having a compressed air-connector (6) in the upper region of the container and a discharge conduit (8) which commences from the floor region of the container (1) and comprises a section (10) adjacent thereto which is situated upwardly in the region of a container wall (15) and can be swiveled away into a flow-out position from an idle position. In order to provide advantageous constructional conditions it is proposed that the rising section (9) of the discharge conduit (8) is provided within the container (1) and is connected with the swivelable section (10) arranged outside of the container (1) via a leadthrough (11) in the container, and that the swivelable section (10) of the discharge conduit (8) is held rotatably in a connection sleeve (12) outside of the container (1).

### FIELD OF THE INVENTION

The invention relates to an apparatus for disposing of liquids in the medical field, especially for disposing of dialysates, comprising a self-supporting container which is movably supported on support wheels and a discharge device for the liquid filled into the container via a sealable filling opening, with the discharge device having a compressed air connector in the upper region of the container and a discharge conduit which commences from the floor region of the container and comprises a section adjacent thereto which is situated upwardly in the region of a container wall and can be swiveled away into a flow-out position from an idle position.

### DESCRIPTION OF THE PRIOR ART

For the purpose of disposing of dialysates it is known (EP 0 865 794 B1) to support a container in the form of a canister on support wheels and to provide the same with a discharge device which comprises in the upper region of the container with a compressed air connector and an outlet opening in the floor region to which a hose of a discharge conduit is connected from the outside. Said discharge conduit is formed by a pipe after the hose which forms a pipe part which is perpendicular to the container floor and is held rotatably about its axis in clamps on a container wall and forms a pipe part which extends transversally thereto and is provided at its free end with a sealing cap. For removing the dialysates, the swivelable section of the discharge conduit can be swiveled from the idle position when swiveled towards the container wall to a discharge position projecting from the container wall in which the compressed air connector is released, so that the container liquid is displaced from the container through the discharge conduit by the compressed air flowing into the container. The disadvantageous aspect is however that by twisting the swivelable section of the discharge conduit the hose portion which is connected in a torsionally rigid fashion to the discharge opening of the container is also twisted about its axis and is therefore subjected to a torsional stress, which in the case of longer use of the apparatus leads to an overload of the hose portion.

### SUMMARY OF THE INVENTION

The invention is thus based on the object of providing an apparatus for disposing of liquids in the medical field, especially for disposing of dialysates, of the kind mentioned above with simple constructional means in such a way that an overload of the discharge conduit can be excluded without having to omit a conduit section that can be swiveled outwardly.

This object is achieved by the invention in such a way that the rising section of the discharge conduit is provided within the container and is connected with the swivelable section arranged outside of the container via a leadthrough in the container and that the swivelable section of the discharge conduit is held rotatably in a connection sleeve outside of the container.

Since as a result of these measures the rising section of the discharge conduit extends within the container, this section of the discharge conduit is protected from outside influences, with the required tightness of the container from leaking being ensured with ease by a respective leadthrough of the container. The rotatable bearing of the swivelable section of the discharge conduit is achieved only outside of the container with the help of the connection sleeve. The sealing of the discharge conduit which is held in a rotatable way relative to the connection sleeve is thus based on reliable technology which as a result of the rotatable bearing of the swivelable section in the connection sleeve prevents a transmission of torsional forces and thus torsional stress on the discharge conduit. Apparatuses in accordance with the invention for disposing of liquids in the medical field therefore do not have any idle times impaired by the discharge device.

Especially advantageous constructional conditions are obtained when the swivelable section consists of a conduit part which extends substantially parallel to the container floor and is held so as to be rotatable about its axis and a conduit part which extends adjacent thereto in a transversal manner, because in this case the largest distance of the discharge opening of the section of the discharge conduit swiveled to the discharge position does not depend on the length of the conduit part parallel to the floor as determined by the container width, but on the conduit part extending transversally thereto, which part extends in the idle position with respect to its height along the container wall, which as a result of a container height which is considerably higher than the container width produces a distance facilitating the handling between the container and the disposal device receiving the liquid from the container.

If the container wall comprises a recessed receiver for the section of the discharge conduit swiveling to the idle position, the section of the discharge conduit which is provided outside of the container can be laid within the contours of the container, which offers additional protection from mechanical damage for the parts of the discharge conduit which are guided outside of the container.

### BRIEF DESCRIPTION OF THE DRAWINGS

The subject matter of the invention is shown by way of examples in the drawings, wherein:

FIG. 1 shows an apparatus in accordance with the invention for disposing of liquids in the medical field in a view of the broad side of the container with the discharge conduit;

FIG. 2 shows a partly elevated view-of the narrow side of the container, and

FIG. 3 shows a sectional view along line III-III of FIG. 1.

### DESCRIPTION OF THE PREFERRED EMBODIMENT

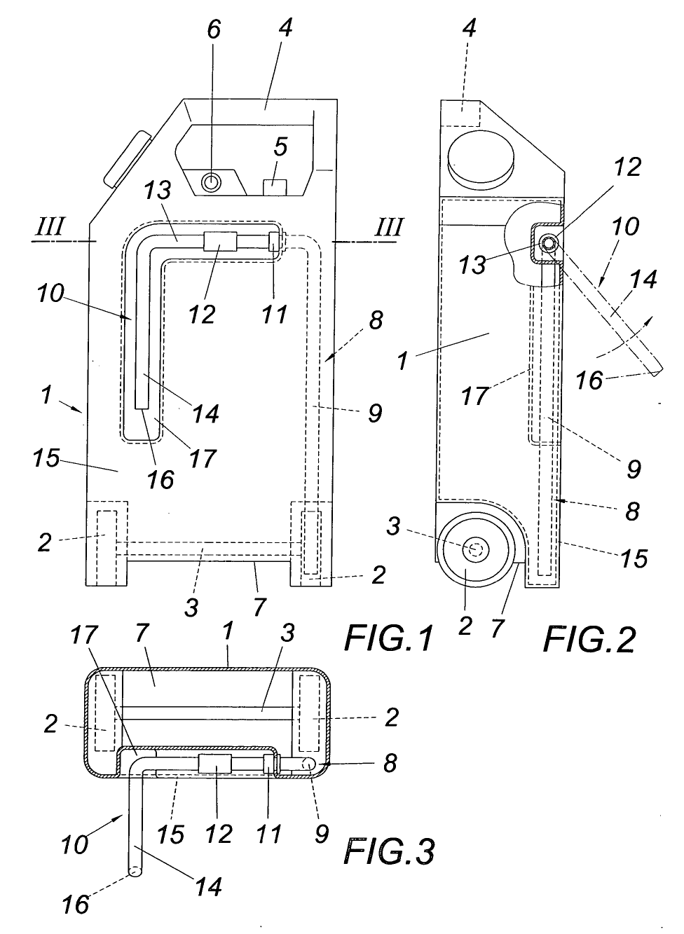

The illustrated apparatus for disposing of liquids, especially of dialysates, comprises a self-supporting container 1 in the form of a container which can be moved on support wheels 2 which are held on a common axle 3 in the container 1. The container 1, which is provided with a handle 4, is provided with a sealable filling opening 5 for the liquid to be disposed of, which liquid can be removed via a discharge device from container 1. Said discharge device comprises a compressed air connector 6 which is provided with a return valve and a discharge conduit 8 which commences from the container floor 7. The configuration is made in such a way that the rising section 9 of the discharge conduit 8 is arranged within the container 1 and is in connection with the swivelable section 10 arranged outside of the container 1 via a container leadthrough 11. The swivelable section 10 of the discharge conduit 8 is rotatably held in a connection sleeve 12 which is located on the outside of the container leadthrough 11. The swivelable section 10 of the discharge line 8 is composed of a conduit part 13 which extends substantially parallel to the container floor 7 and an adjacent conduit part 14 which extends transversally thereto. In the idle position of the swivelable section 10 when swiveled towards the container wall 15, the conduit part 14 extends according to FIG. 1 in the direction of the height of the container, which provides a sufficient length for the conduit part 14 in order to achieve a respective distance of the outlet opening 16 from the container 1 when section 10 is swiveled out.

To ensure that the swivelable section 10 of the discharge conduit 8 does not project beyond the contours of the container 1 in a disturbing manner, a recessed receiver 17 is provided in the container wall 15 for the section 10 of the discharge conduit 8 swiveled to the idle position.

1. An apparatus for disposing of liquids in the medical field, especially for disposing of dialysates, comprising a self-supporting container which is movably supported on support wheels and a discharge device for the liquid filled into the container via a sealable filling opening, with the discharge device having a compressed air connector in the upper region of the container and a discharge conduit which commences from the floor region of the container and comprises a section adjacent thereto which is situated upwardly in the region of a container wall and can be swiveled away into.a flow-out position from an idle position, wherein the rising section (9) of the discharge conduit (8) is provided within the container (1) and is connected with the swivelable section (10) arranged outside of the container (1) via a leadthrough (11) in the container, and the swivelable section (10) of the discharge conduit (8) is held rotatably in a connection sleeve (12) outside the container (1).

2. An apparatus according to claim 1, wherein the swivelable section (10) consists of a conduit part (13) which extends substantially parallel to the container floor (7) and is held so as to be rotatable about its axis and of a conduit part (14) which extends adjacent thereto in a transversal manner.

3. An apparatus according to claim 1, wherein the container wall (15) forms a recessed receiver (17) for the section (10) of the discharge conduit (8) which is swiveled into the idle position.
